(19) United States
(12) Patent Application Publication
(10) Pub. No.: US 2010/0161404 A1
(43) Pub. Date: Jun. 24, 2010

(54) PROMOTIONAL ITEM IDENTIFICATION IN PROCESSING OF AN ACQUIRED TRANSACTION ON AN ISSUED ACCOUNT

(76) Inventors: Mary Theresa Taylor, San Francisco, CA (US); Karen L. Cervenka, Belmont, CA (US); Shilpak Mahadkar, Oakland, CA (US); Barbara Elizabeth Patterson, South San Francisco, CA (US)

Correspondence Address: Quarles & Brady LLP, TWO NORTH CENTRAL AVENUE, One Renaissance Square, PHOENIX, AZ, 85004-2391, US

(21) Appl. No.: 12/624,184

(22) Filed: Nov. 23, 2009

Related U.S. Application Data
(60) Provisional application No. 61/117,846, filed on Nov. 25, 2008.

(51) Int. Cl. G06Q 20/00; G06Q 30/00

(52) U.S. Cl. 705/14.38; 705/44

(57) ABSTRACT

Disclosed methods enable an open loop system processing of private label and co-branded account transactions. Implementations in the open loop system employ communications directly between a merchant and an issuer offering promotional financing for a promotional item being purchased from the merchant. Other implementations in the open loop system enable different transaction amounts in an authorization request message and its corresponding authorization response as are respectively sent and received by a merchant, where the different can be for a promotion offered to an accountholder for conducting a transaction on an account with the merchant.

### RELATED APPLICATIONS

This application claims priority to U.S. Provisional Application Ser. No. 61/117,846, filed on Nov. 25, 2008, titled “Promotional Item Identification In Private Label and Co-Branded In-Store Processing Of An Acquired Transaction On An Issued Account,” which is incorporated hereby by reference.

### FIELD

The invention is related to a payment processing system in which a transaction between a merchant and a consumer is conducted on an account issued by an issuer. The transaction is acquired from the merchant by an acquirer for collection on the account from the issuer through a transaction handler or transaction processor. A promotional offer is made to the consumer for conducting the transaction. The account is issued for a private label or a co-branded consumer payment device.

### BACKGROUND

In order to provide a consumer with a promotional offer for purchasing an item in a transaction on an account, there is a need to accurately identify the item being purchased in the transaction and then act upon the promotion. It is a typical retail technique for a merchant or an issuer to offer consumers such promotional offers for a private label account where the account is issued by the merchant, or in a closed loop system for processing the transaction where the issuer and the merchant's acquirer are one and the same and communicate messaging for transactions on accounts. For instance, a promotion to a consumer may be the offer to purchase a specific item for which payment would be made on a private label account with a line of credit carried by a merchant, where the account would be opened at a merchant's Point of Service terminal (POS), such that an open system credit or debit account would not be needed.

Unsolved problems exist with private label accounts and closed loop system processing of transactions on these types of accounts. For instance, as compared to open loop system transaction processing, where there is an issuer and acquirer that communicate messaging for transactions on accounts through a transaction handler (e.g.; Visa Inc., MasterCard, etc.), private label and closed system transaction processing typically both lack efficiency, have high installation and maintenance costs, and are less robust in their ability to handle large numbers of transactions. The present disclosure addresses these problems.

### BRIEF DESCRIPTION OF THE DRAWINGS

Implementations of the invention will become more apparent from the detailed description set forth below when taken in conjunction with the drawings, in which like elements bear like reference numerals.

FIGS. 1-8 depict flow charts of respective exemplary processes within the environment of FIGS. 1, 9 and 10;

FIG. 9 illustrates an exemplary payment processing network.

FIG. 10 depicts an exemplary process for of a particular financial transaction system, having various components as illustrated, in which there is a provision of a service by a merchant to a consumer in authorizing and remunerating electronic payment by an account holder in conducting a financial transaction on an account with the merchant (i.e.; a credit card transaction).

FIG. 11 illustrates systems housed within an interchange center to provide online and offline transaction processing; and

FIG. 12 illustrates another view of the components of FIG. 10.

Implementations will become more apparent from the detailed description set forth below when taken in conjunction with the drawings, in which like elements bear like reference numerals.

### SUMMARY

The present application provides a processing environment for a transaction conducted upon an account by a consumer with the merchant. The account is identified with a private label or co-branded portable consumer transaction payment device, such as a debit or credit card. The consumer is taking advantage, via the transaction, of a promotional offer for purchasing an item in the transaction on the account. To conduct the transaction, the item is identified. Instead of processing the transaction by financial messaging in a closed loop system, the transaction is processed in an open loop system where there is an issuer and a different acquirer that communicate financial messaging for the transaction on the private label or co-branded account through a transaction handler (e.g.; Visa Inc., MasterCard, etc.). As such, the private label or co-branded account transaction will be processed so as to realize efficiency through an open loop system.

The open loop system processing of a transaction on a private label or co-branded account should be subjected an authorization which requires approval by the issuer of the account. The present application discloses processing in a open loop system of a transaction on a private label or co-branded account for an amount requested for authorization that is different that an amount that is approved for authorization (i.e.; partial authorization), such as where a reward or promotional discount is offered to the consumer for conducting the transaction on the account. Also disclosed is processing in a open loop system of a transaction that includes a party responsible for repayment of the reward or promotional discount given to the consumer for conducting the transaction on a private label or co-branded account. The present application further discloses a process by which promotional financing can be offered to a consumer in a open loop system for a transaction on a private label or co-branded account.

Some of the disclosed implementations employ communications directly between a merchant and an issuer offering promotional financing for a promotional item being purchased from the merchant. Other disclosed implementations enable different transaction amounts in an authorization request message and its corresponding authorization response as are respectively sent and received by a merchant, where the different can be for a promotion offered to an accountholder for conducting a transaction on an account with the merchant.

Efficiency benefits can be accomplished by implementations disclosed in the present application of open loop system processing of a transaction on a private label or co-branded account that would normally be processed in a closed loop system, that is, where the issuer (i.e.; the cardholder's bank) and the merchant's bank (i.e.; the acquirer) are both the same entity. Split ticket open loop system processing of such a transaction can be also be accomplished so that the transaction can be settled at different points in the open loop system. As such, more merchants than otherwise can accept private label or co-branded cards and yet still be able to use the efficiency and the robustness of open loop processing.

### DETAILED DESCRIPTION

The present discussion considers an improvement to the current industry practice of a consumer using a private or co-branded account, as may be represented by a credit or charge card, to obtain financing or a reward from a merchant for purchasing an item on an account issued by an issuer to the consumer that is associated with the private label or co-branded account, where the item is purchased in a transaction between the consumer and a merchant. The private label card is one that can only be used to make purchases with the merchant and none other (e.g., a card can be used only at “The Gap” retail stores or only at “Macys” department stores). In such cases, often referred to as a ‘closed loop’ transaction, the reward and the financing is dealt with as being between the consumer, the merchant, and/or the issuer.

In contrast, a co-branded card may be used at many different merchants to make purchases (e.g., a Southwest Airlines Visa Card). Such a transaction is often referred to as an ‘open loop’ transaction. Disclosed implementations identify for the merchant, acquirer and issuer how a transaction handler or processor (transaction handler) can support techniques to identify an item in a transaction that is subject to a promotion. Such techniques include use of product level data, level three data, Stock Keeping Units (SKU), and/or Universal Product Codes (UPC) in order to identify item promotions and merchant discounting. Disclosed implementations also identify how to employ instant rewards to the consumer at the merchant's Point of Service terminal (POS) at the time of the purchase, and how to employ rewards that are not given to the consumer until the time of posting on the account of the consumer that was used to conduct the transaction at with the merchant. Disclosed implementations support product/SKU level promotions, merchant discounting based on SKU, a promotion paid by a sponsor (e.g., wholesaler(s)/distributor(s)/manufacturer(s)) of the item through the open system via the transaction handler, and techniques for deploying instant POS discounts (e.g., for rewards or promotions, including an initial purchase discount).

Exemplary solutions are identified for the following business applications: (a) Co-brand/Private Label promotional financing; (b) Special merchant discounting based on individual product/items purchased; (c) Sponsored (e.g.; Manufacturer) Financing of Promotional Item Sales; (d) Initial Purchase Discount (at Authorization or at Posting); and (e) Real-Time POS Rewards.

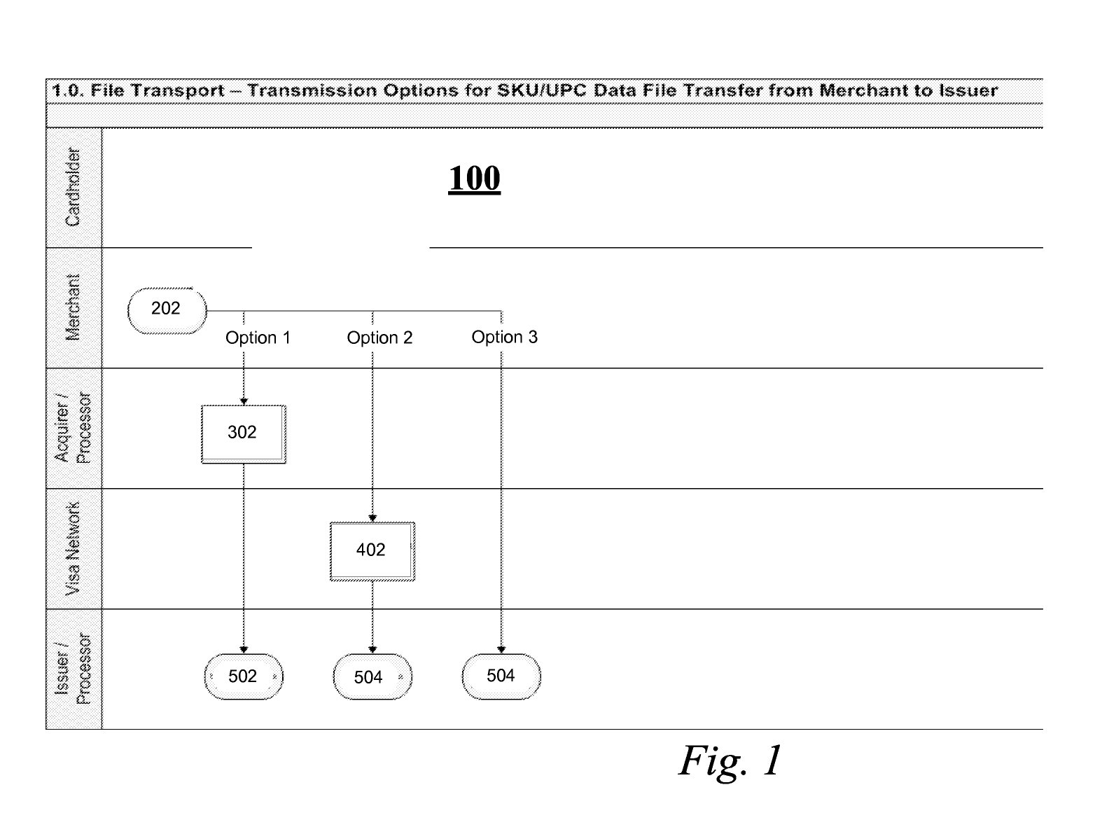

Referring now to FIG. 1, an exemplary process 100, labeled ‘1.0 File Transport: Promotional Financing by SKU’, shows an open loop work flow depicted by ‘swim lanes’, where each swim lane reflects processes conducted by an entity, namely the cardholder, the merchant, the Acquirer/Processor; the Transaction Handler (e.g.; Visa Network); and the Issuer/Processor).

In FIG. 1, a SKU/UPC data is optionally transmitted from the merchant to other swim lanes. For instance, the Issuer gets information about an item being purchased in a transaction that is to be awarded promotional financing (i.e., ‘2-10, net 30’; special promotion financing terms such as ‘90 Days same as cash’ or No interest until the end of the year', etc). FIG. 1 shows how such a transaction, which may have otherwise been conducted in an issuer or merchant based closed loop, can be conducted in an open loop network. Note that more loyalty can be built up with each of additional parties in the open loop system, whereas the acquirer and issuer are the same in a closed loop.

In FIG. 1, there is depicted a flowchart illustrating an exemplary process 100 depicting three (3) different options for transaction data transmission for transmitting a Stock Keeping Unit (SKU) or Universal Product Code (UPC): data file transfers from a Merchant to an Issuer.

The Merchant Step in FIG. 1 is: 202: Transmit the Stock Keeping Unit (SKU) or Universal Product Code (UPC) data file (Includes Transaction ID, Dollar Amount, Account Number, and all Item Level Details).

The Acquirer/Processor Steps in FIG. 1 are 302: Option 1: Receive file from Merchant and initiate file transfer over Visa Network Switch Direct Exchange (Visa DEX) protocols via the Visa Network.

The Transaction Handler (i.e. Visa Network) Step in FIG. 1 is: 402: Option 2: Receive SKU/UPC data from Merchant and transmit to Issuer.

The Issuer/Processor Steps in FIG. 1 are: 502: Option 1: Receive file transfer via Visa DEX network; and 504: Option 2: Receive SKU/UPC data from Visa; 506: Option 3: Receive SKU/UPC data from Merchant.

Implementations With Communications Directly Between Merchant and Issuer Offering Promotional Financing.

In one implementation, a method can be performed by hardware executing software. The method is conducted at a merchant who receives information for a transaction for a purchase of a promotion item and a non-promotional item. The information includes an identifier for: (i) an account issued by an issuer to the accountholder for the transaction which is being conducted on the account between the merchant and the accountholder; and (ii) the promotional item. The account is limited to be used for transactions with the merchant and no other. The merchant sends an authorization request for the transaction for delivery to the issuer through a communication path through an acquirer and a transaction handler before the delivery to the issuer. The merchant receives back an authorization response to the authorization request from the acquirer. The merchant also sends, in a transmission directly from the merchant to the issuer, a promotional item settlement request that includes: (i) the identifier for the promotional item; (ii) the identifier for the account; and (iii) an identifier for the transaction. After receiving the authorization request and sending the promotional item settlement request, the merchant sends a transaction clearing request for the transaction for delivery to the issuer through a communication path through the acquirer and the transaction handler before the delivery to the issuer. The merchant the received a promotional item clearing response to the promotional item settlement request. The promotional item clearing response includes settlement information corresponding to promotional financing from the issuer to the accountholder that is derived from the identifier for the promotional item. The merchant also receives from the acquirer a transaction clearing response to the transaction settlement request.

In one alternative, the issuer can be acquirer. In another alternative, the authorization response can include an indicator that the transaction is the first such transaction conducted on the account. If so, then the authorization request and the authorization response can include different amounts for the transaction, where the difference between the respective amounts in the authorization request and the authorization response can be based upon either or both of the transaction being the first such transaction conducted on the account and the identifier for the promotional item. In yet another alternative, the transaction can be processing for authorization, clearing and settlement in an open loop system. As such the transaction handler can respectively receive and send a plurality of other such authorization requests and other such authorization responses, where each are for other such transactions conducted on respective other such account, and where each of the other accounts can be used to conduct transactions with more than such one merchant, but with different merchants.

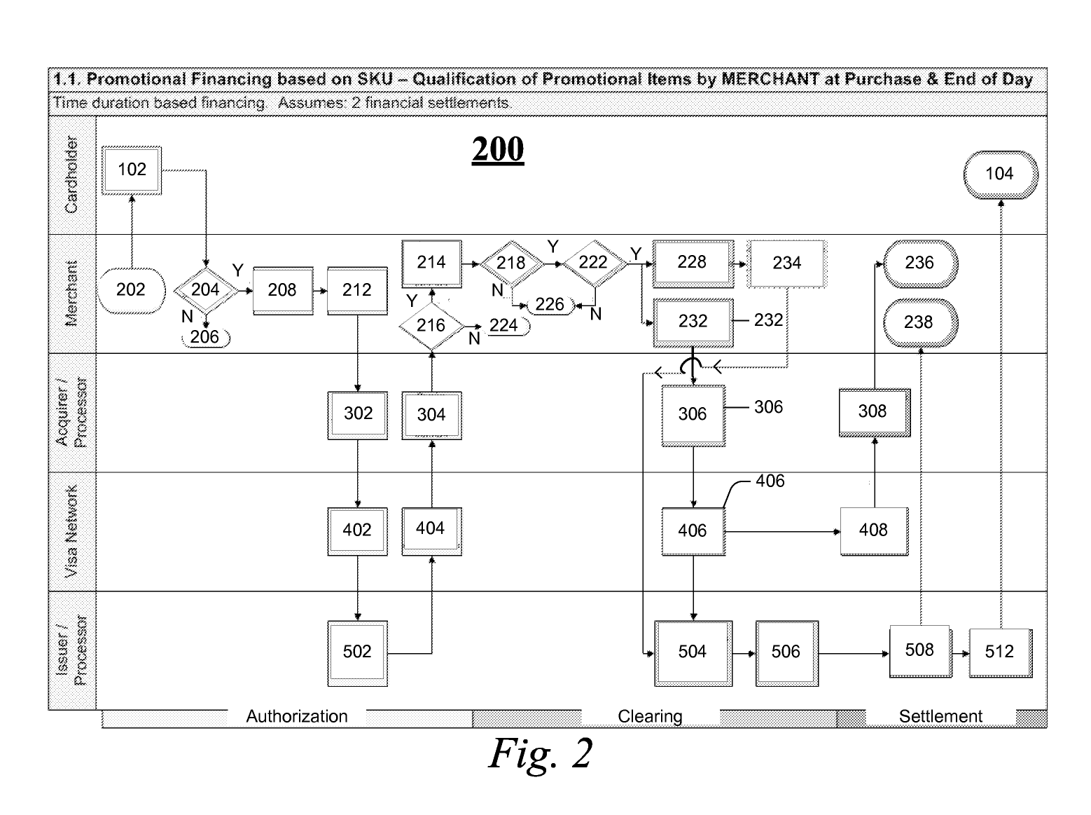

In general, FIGS. 2-6 are exemplary of the above implementation in which there are communications directly between a merchant and an issuer offering promotional financing.

FIG. 2 depicts at 1.1 a flowchart illustrating an exemplary process 200 for determining promotional financing (time duration based financing) based upon the SKU of an item in a transaction, where the qualification of the promotional item is performed by the merchant within the transaction and at the end of the day, where process 200 assumes two (2) financial settlements. FIG. 2 can apply to Co-brand or Private Label promotional financing of purchases and also to special merchant discounting based on individual product/items purchased.

The merchant can perform the qualification of the financing promotion by communicating the promotional financing information using a special field in a message for the transaction called a ‘Multiple Clearing Sequence Number’ (MCSN) field. A merchant or acquirer can, based on the private label or co-brand issuer Bank Identification Number (BIN), interrogate the contents of a shopping basket to determine if there are any items present that qualify for a promotion. If so, the merchant would indicate that determination in a transmitted message that the transaction contains a promotional item in the shopping basket. To do so, the merchant populates a special value (“promotional code”) in specified fields of the Visa authorization, and/or clearing and settlement records. Additionally (or alternatively), the merchant/acquirer can create a clearing record for the promotional item, separate from the rest of the items purchased, to allow for special issuer handling of the qualified promotional item, associating both clearing items together using the MCSN field.

Alternatively, if not using the MCSN field, the issuer can match the incoming transactions from the Transaction Handler (i.e., Visa Network) with the shopping basket line item detail sent separately from the merchant. The issuer interrogates product/SKU level data and calculates the merchant discount. The Issuer processes the appropriate promotional terms to the cardholder's purchase.

FIG. 2 shows the option of the merchant qualifying with separate clearing messages or by separately identifying the items where the merchant has knowledge of those items that have promotional financing. As such FIG. 2 depicts at 1.1 a flowchart illustrating an exemplary process 200 for determining promotional financing (time duration based financing) based upon the SKU of an item in a transaction, where the qualification of the promotional item is performed by the merchant within the transaction and at the end of the day, and where process 200 assumes two (2) financial settlements.

The Cardholder Step in FIG. 2 is: 102: Swipe card at POS (Authorization Process); 104: Statement to cardholder (Settlement Process).

The Merchant Steps in FIG. 2 are: 202: Inventory goods in basket (Authorization Process); 204: Is Bank Identification Number (BIN) co-brand or Private Label (PL)? (Authorization Process); 206: No—Business As Usual (‘BAU’), meaning the ordinary transaction processing procedures are followed (Authorization Process); 208: Yes—Evaluate SKU/UPC against promo database (Authorization Process); 212: Send Authorization request message for purchase total; 216: Is authorization approved?; 214: Yes—Receive authorization response message & complete purchase; 218: Is BIN Co-brand or PL? (Clearing Process); 224: No—BAU (Authorization Process); 222: Is item promotional? (Clearing Process); 226: No—BAU (Clearing Process); 228: Yes—Denote promo items and send clearing data to Acquirer (Clearing Process); 234: (Or—Break out promo items separately and send clearing data to Acquirer) (Clearing Process); 232: Send SKU/UPC to Issuer (include transaction ID and card #) (Clearing Process); 236: Settle entire purchase amount with Acquirer (Settlement Process); and 238: Settle promo items with Issuer (Settlement Process).

The Acquirer/Processor Steps in FIG. 2 are: 302: Receive authorization request message & send to Visa (Authorization Process); 304: Receive authorization response message and send to merchant (Authorization Process); 306: Map proprietary clearing data into Visa clearing item(s) and send to Visa (Clearing Process); and 308: Receive settlement report, calculate discounts and send to Merchant (Settlement Process).

The Transaction Handler (i.e., Visa Network) Steps in FIG. 2 are: 402: Receive authorization request message and send to Issuer (Authorization Process); 404: Receive authorization response message and send to Acquirer (Authorization Process); and 406: Receive clearing data and send to Issuer (Clearing Process); 408: Calculate settlement between Acquirer and Issuer; provide reporting; send wire (This is the first settlement).

The Issuer/Processor Steps in FIG. 2 are: 502: Validate authorization request message and send authorization response message (Authorization Process); 504: Interrogate contents of SKU/UPC file or individual clearing items (Clearing Process); 506: Calculate settlement for promo items (Clearing Process); 508: Initiate settlement for promo items (Settlement Process); and 512: Process data for Cardholder statement (This is the second settlement) (Settlement Process).

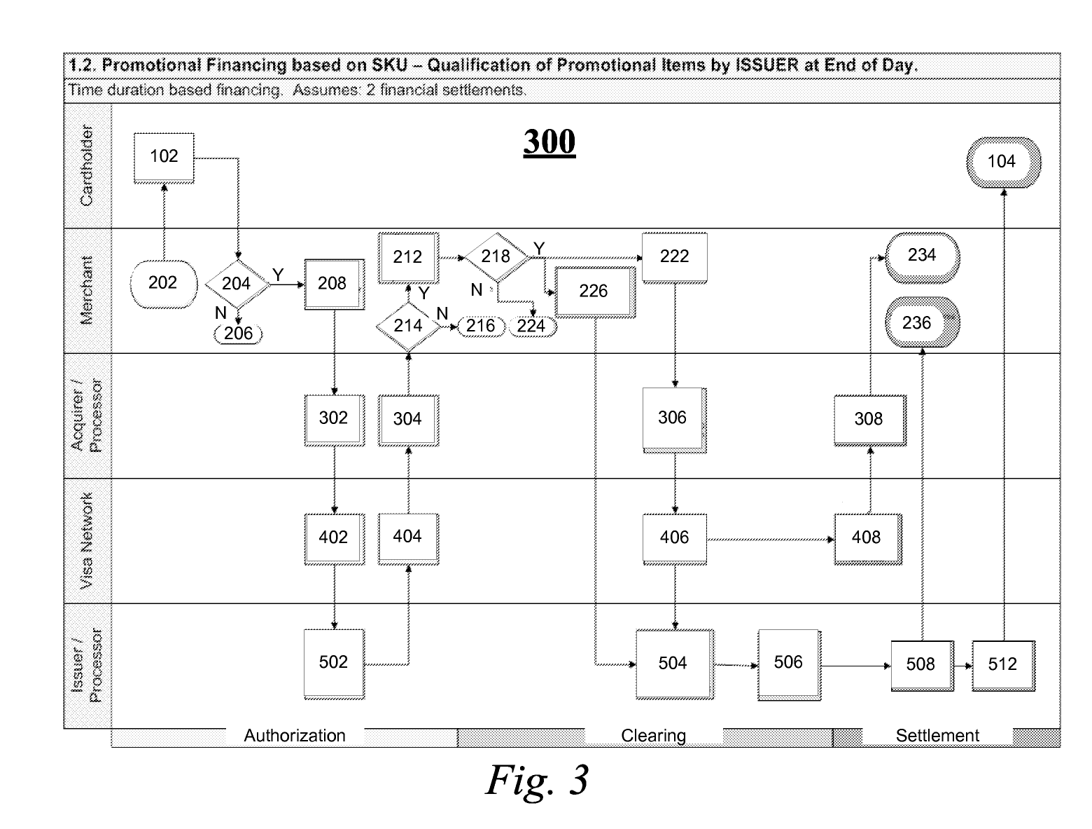

FIG. 3 depicts at 1.2 a flowchart illustrating an exemplary process 300 for determining promotional financing (time duration based financing) based upon the SKU of an item in a transaction, where the qualification of the promotional item is performed by the Issuer of the account upon which the transaction is conducted and is determined at the end of the day, and where process 300 assumes two (2) financial settlements.

The Cardholder Step in FIG. 3 is: 102: Swipe card at POS; 104: Statement to cardholder (Settlement Process).

The Merchant Steps in FIG. 3 are: 202: Inventory goods in basket (Authorization Process); 204: Is BIN co-brand or PL? (Authorization Process); 208: Yes—Send Authorization request message for purchase total (Authorization Process); 206: No—BAU (Authorization Process); 214: Is authorization approved? (Authorization Process); 212: Yes—Receive authorization response message and complete purchase (Authorization Process); 216: No—BAU (Authorization Process); 218: Is BIN Co-brand or PL? (Clearing Process); 226: Yes—Send SKU/UPC to issuer (include transaction ID and card #) (Clearing Process); 224: No—BAU; 222: Send clearing data to Acquirer (Clearing Process); 234: Settle entire purchase amount with Acquirer (Settlement Process); and 236: Settle promo items with Issuer (Settlement Process).

The Acquirer/Processor Steps in FIG. 3 are: 302: Receive authorization request message and send to Visa (Authorization Process); 304: Receive authorization response message to send to Merchant (Authorization Process); 306: Map proprietary clearing data from Merchant into Visa Clearing item(s) and send to Visa (Clearing Process); and 308: Receive settlement report, calculate discounts and send to Merchant (Settlement Process).

The Transaction Handler (i.e., Visa Network) Steps in FIG. 3 are: 402: Receive authorization request message & send to issuer (Authorization Process); 404: Receive authorization response message and send to Acquirer (Authorization Process); 406: Receive clearing data and send to Issuer (Clearing Process); 408: Calculate settlement bet Acquirer and Issuer; provide reporting; send wire (This is the first settlement) (Settlement Process).

The Issuer/Processor Steps in FIG. 3 are: 502: Validate authorization request message and send authorization response message (Authorization Process); 504: Interrogate contents of SKU/UPC from Merchant, qualify items by SKU and perform any (Clearing Process); Special merchant settlement; 506: Calculate settlement for promo items (This is the second settlement) (Clearing Process); 508: Initiate settlement for promo items (Settlement Process); and 512: Process data for Cardholder statement (Settlement Process).

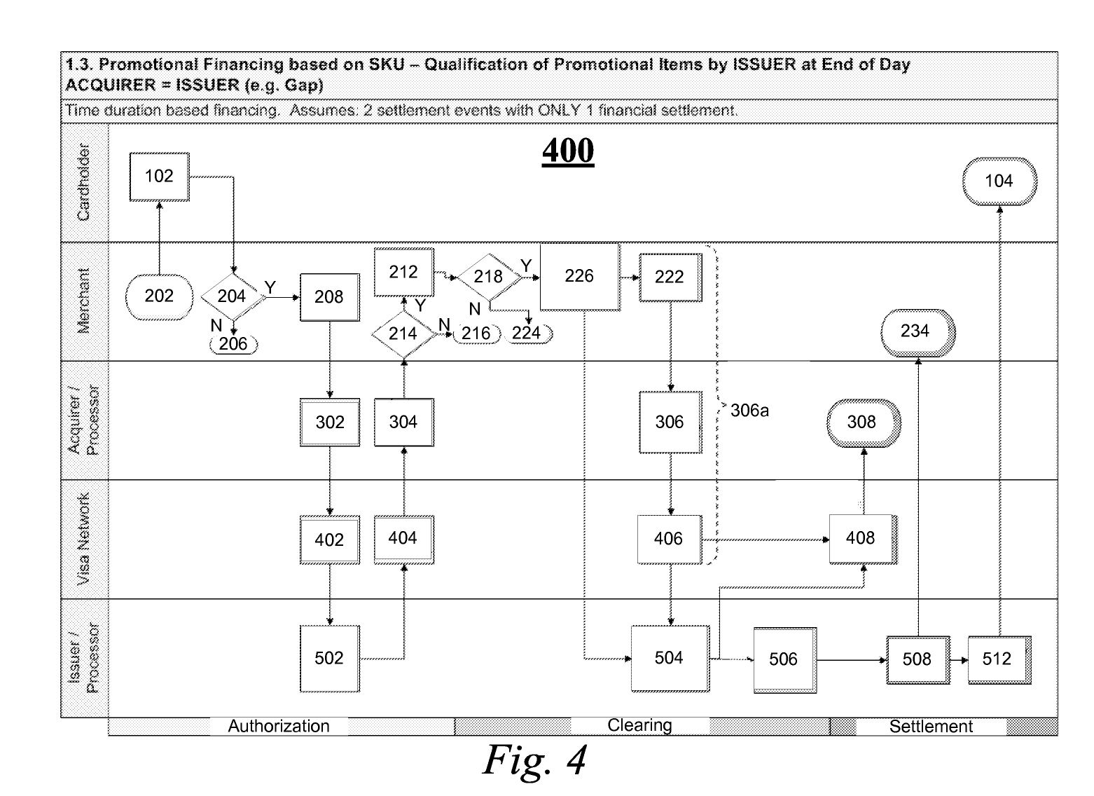

FIG. 4 depicts at 1.3 a flowchart illustrating an exemplary process 400 for determining promotional financing (time duration based financing) based upon the SKU of an item in a transaction, where the qualification of the promotional item is performed by the Issuer of the account upon which the transaction is conducted and is determined at the end of the day, and where process 400 assumes two (2) settlement events only one (1) of which is a financial settlement, and where the acquirer and the issuer are the same entity, such as a private label merchant (e.g., The Gap clothing store).

In FIG. 4, at step 222, labeled “Send 1 or 2 clearing files to Acquirer”, is a reference to the merchant's and acquirer's complexity for data handling to use existing relations (non-in-store with just 1 file, or 2 different files), where the use of 1 file is traditional for an open system transaction, whereas the other separate files are an in-store transaction for which there can be multiple and different acquirers for each of these 2 different and separate files. Note also that the Merchant transmits, at step 226, to the issuer all information about the transaction in one (1) of the work flows.

The Cardholder Steps in FIG. 4 are: 102: Swipe card at POS (Authorization Process); and 104: Statement to cardholder (Settlement Process).

The Merchant Steps in FIG. 4 are: 202: Inventory goods in basket (Authorization Process); 204: Is BIN Co-brand or PL? (Authorization Process); 208: Yes—Send Authorization request message for purchase total (Authorization Process); 206: No—BAU (Authorization Process); 214: Is authorization approved? (Authorization Process); 212: Yes—Receive authorization response message and complete purchase (Authorization Process); 216: No—BAU (Authorization Process); 218: Is BIN Co-Brand or PL? (Clearing Process); 226: Yes—Send SKU/UPC to issuer (include transaction ID and card #), or if 1 SKU/UPC, Then can send in clearing (Clearing Process); 224: No—BAU (Clearing Process); 222: Send 1 or 2 clearing files to Acquirer (Clearing Process); and 234: Settle promo items with Issuer (Settlement Process).

The Acquirer/Processor Steps in FIG. 4 are: 302: Receive Authorization request message and send to Visa (Authorization Process); 304: Receive Authorization response message and send to Merchant (Authorization Process); 306: Map proprietary clearing data from Merchant into Visa clearing item(s) and send to Visa; (Note: Steps 222, 206 and 406 are based on BIN, Account Range, or Merchant ID, 2 clearing files for settlement purposes are created at one of these 3 processes: 1) Acquirer & Issuer; 2) BAU)); and 308: Receive settlement report (Settlement Process).

The Transaction Handler (i.e., Visa Network) Steps in FIG. 4 are: 402: Receive authorization request message & send to Issuer (Authorization Process); 404: Receive authorization response message and send to Acquirer (Authorization Process); 406: Receive clearing data and send to Issuer; 408: Calculate settlement between Acquirer & Issuer; provide reporting; send wire (This is the first settlement Nets to zero (e.g. GE/Gap flow)) (Settlement Process).

The Issuer/Processor Steps in FIG. 4 are: 502: Validate authorization request message and send authorization response message (Authorization Process); 504: Interrogate contents of SKU/UPC from Merchant, qualify items by SKU and perform any Special merchant settlement (This is the second settlement); 506: Calculate settlement for promo items; 508: Initiate settlement for promo items (Settlement Process); and 512: Process data for cardholder statement (Settlement Process).

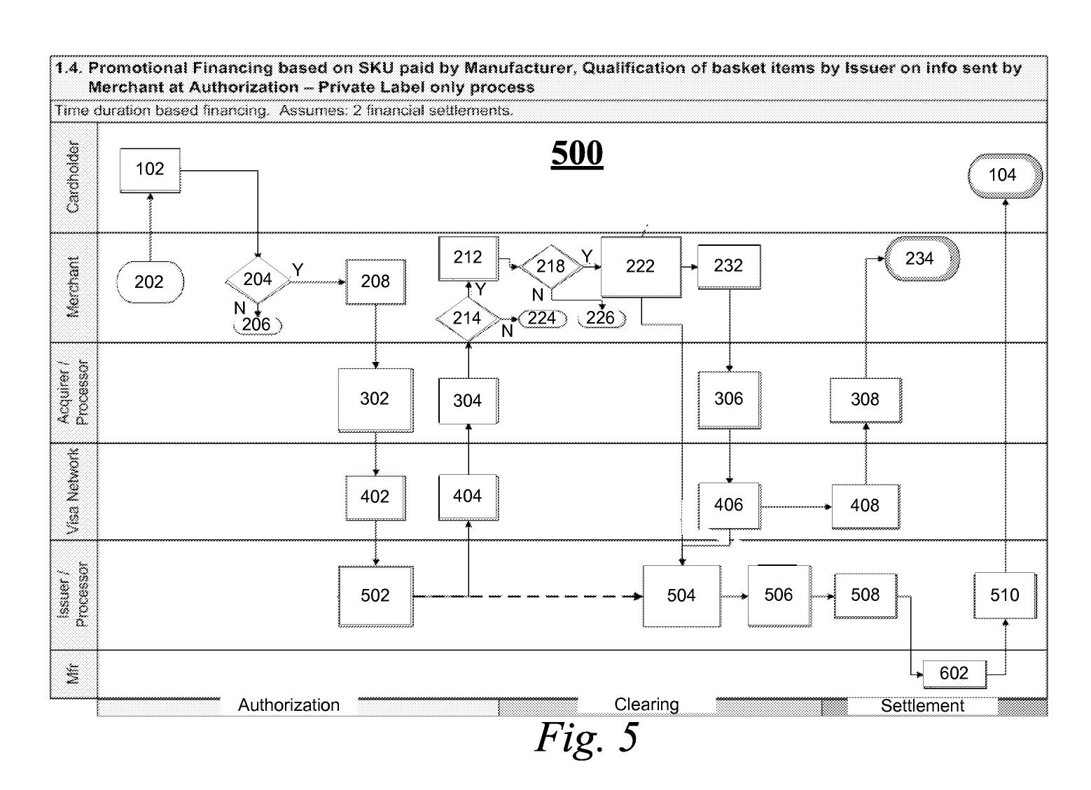

FIG. 5 depicts at 1.4 a flowchart illustrating an exemplary process 500 for determining promotional financing (time duration based financing) based upon the SKU of an item in a transaction, where the promotional financing is sponsored by the manufacturer of the item being financed, where the qualification of the item for the promotional financing is performed by the Issuer of the account upon which the transaction is conducted, where the qualification is based upon information sent by the Merchant to the Issuer at the time of the Authorization Process, and where process 500 assumes two (2) settlements.

Process 500 is predicted on the Merchant having a way for the Cardholder to apply for a line of credit with the Manufacturer's Issuer (the Issuer who issues an account to the Manufacturer of the item being purchased in a transaction by the Cardholder with the Merchant, where the transaction is conduced on that issued account). Once the account is assigned by the Manufacturer's Issuer, then the purchase can occur. Usually, there is only one (1) item being purchased by the Cardholder in the transaction, namely the item made by the Manufacturer. The Merchant is ‘made whole’ for the full value of the purchase, and the Issuer collects the “Merchant Discount” from the Manufacturer.

In Process 500, the Merchant/Acquirer initiates authorization with an UPC/SKU in an authorization message that is switched through the Transaction Handler (i.e., Visa Net) to the Issuer who validates a line of credit used only for the manufacturer's good. The merchant/acquirer has the ability to submit the UPC/SKU in a clearing message. Settlement takes place in a Business As Usual (BAU) process through the Transaction Handler (i.e., Visa Net). The issuer settles outside of the Transaction Handler (i.e., Visa Net) with manufacturer.

Rather than opening a private label account with a line of credit at the POS such that an open system credit or debit account would not be needed, process 500 can be a pre-paid credit line where the consumer offers a payment device to a merchant who knows that the consumer is buying an item that can have promotional financing. The card holder experience is to pay at the POS with any account or even cash. The consumer conducts a transaction with the merchant to buy an item. The transaction is conducted on the account issued to the consumer. If only one of two items being purchased has promotional financing (i.e., a washing machine has promotional financing but a candy bar doesn't), then there can be two (2) different transactions that are conducted: The interrogation identifies the item with the promotional financing where the data is with the issuer-processor who sees the SKU/UPC. The manufacturer of the promotional item might only be contacted at settlement in order to get the manufacturer to pay back the merchant so as to make the merchant whole for the discounting done by the merchant. The ‘participating’ merchants should have a relationship with an acquirer.

The Cardholder Steps in FIG. 5 are: 102: Enter account number at POS (could have application process but no card Issued at POS) (Authorization Process); and 104: Statement to cardholder (Settlement Process).

The Merchant Steps in FIG. 5 are: 202: Inventory goods in basket (Authorization Process); 204: Is BIN PL? (Authorization Process); 208: Yes—Send authorization request message and SKU/UPC in the message (Authorization Process); 206: No—BAU (Authorization Process); 214: Is authorization approved? 212: Yes—Receive authorization response message and complete purchase; 224: No—BAU (Clearing Process); 218: Is BIN PL? (Clearing Process); 222: Yes—Send SKU/UPC to Issuer (include transaction ID and an identifier for the account—e.g.; card #number). One (1) or two (2) clearing files can be sent to the Acquirer. If one (1) clearing file is sent to the Acquirer, then the SKU/UPC can be sent in the clearing file data (i.e.; the UPC can be sent: (i) in either the promo description area of the clearing item since there's likely few specific UPC's; or (ii) the merchant can send a separate file) (Clearing Process); 226: No—BAU (Clearing Process); 232: Send clearing data to Acquirer (Clearing Process); and 234: Settlement of the entire purchase amount with Acquirer (Settlement Process).

The Acquirer/Processor Steps in FIG. 5 are: 302: Receive authorization request message and send to Visa with SKU/UPC in field 104 of Visa Message (Authorization Process); 304: Receive Authorization response message and send to Merchant (Authorization Process); 306: Map proprietary clearing data from Merchant into Visa clearing item(s) and send to the Transaction Handler (i.e., Visa (Clearing Process)); and 308: Receive settlement report, calculate discounts and send to Merchant (Settlement Process).

The Transaction Handler (i.e., Visa Network) Steps in FIG. 5 are: 402: Receive Authorization request message and send to Issuer (Authorization Process); 404: Receive Authorization response message to send to Acquirer (Authorization Process); 406: Receive clearing data and send to issuer (Clearing Process); and 408: Calculate settlement between Acquirer and issuer; provide reporting; send wire. (Settlement Process).

The Issuer/Processor Steps in FIG. 5 are: 502: Validate Authorization request message, validate and record SKU, then send authorization response message (This will usually require that the SKU/UPC to be included within the authorization message as a line of credit that is only good for the manufacturer's product (e.g. specific DVD, TV over $500, etc.)) (Authorization Process); 504: Interrogate contents of SKU/UPC from Merchant, qualify items by SKU to perform any Special manufacturer settlement (Clearing Process); 506: Calculate fee to charge manufacturer (Clearing Process); 508: Initiate Settlement to manufacturer for fees (This is the second settlement Process); and 510: Process data for Cardholder statement (Settlement Process).

The Manufacturer (Promotion Sponsor) Step in FIG. 5 is 602: Settle with Issuer for manufacturer paid discounts (Settlement Process).

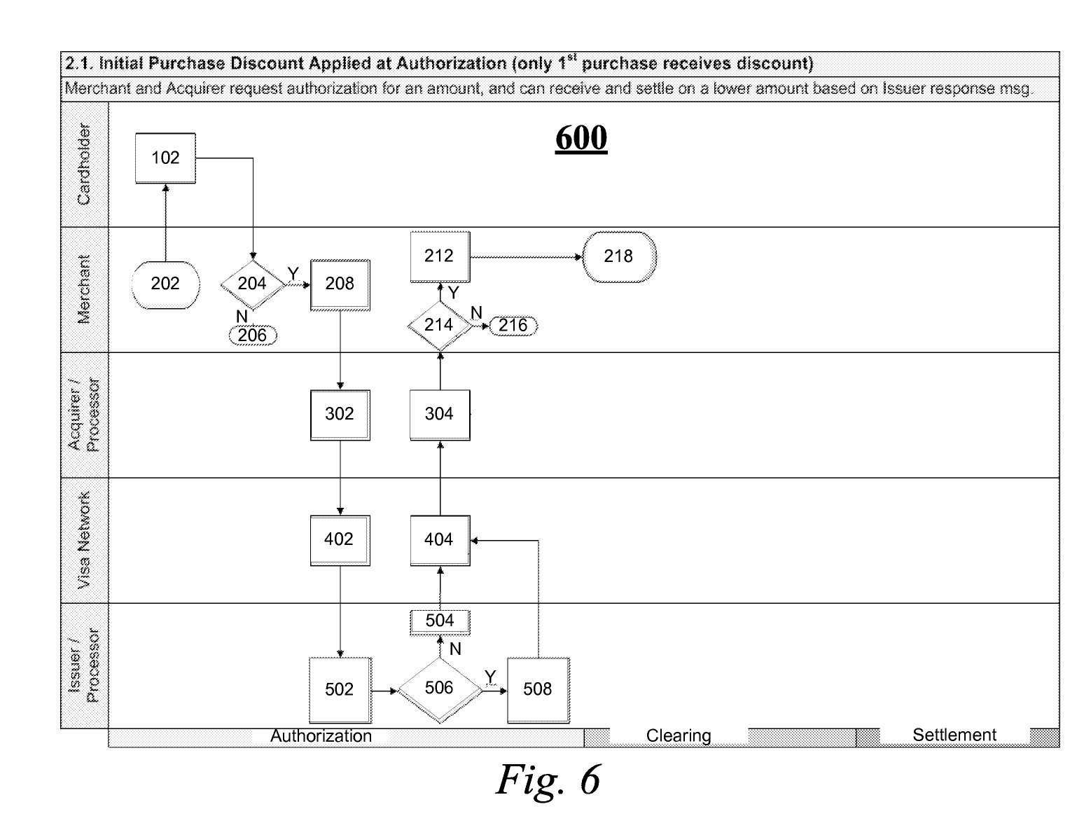

FIG. 6 at 2.1 labeled “Initial Purchase Discount at Authorization” depicts a flowchart illustrating an exemplary process 600 for determining a promotional discount that applies at the time that an item is purchased in a transaction, where the discount is applied in the Authorization Process, where the discount is only applied to a qualifying event (for instance, for only the first (1st) purchase using an account), and where the Merchant and the Acquirer request authorization for the purchase amount of the item and can receive and settlement a lower amount based upon a response given by the Issuer in the Authorization Process. 2.1. Here, upon identification of the qualifying event, the issuer gives an instant discount where a merchant and an acquirer initiate an authorization request for the full purchase amount, indicating that the POS has the capability to settle an amount less than the amount in the authorization request. The issuer receives the authorization request message and interrogates its system to determine there has been no previous purchase on the account. If there is no previous purchase, using a unique response code, the issuer replies with an authorization response message containing an amount less than the requested amount, discounted as needed (10% off, 20% off, etc). The POS recognizes this unique response code, creates an appropriate receipt, and creates a settlement record for the approved amount.

The Cardholder Step in FIG. 6 is 102: Swipe card at POS (Authorization Process).

The Merchant Steps in FIG. 6 are 202: Inventory goods in basket (Authorization Process); 204: Is BIN Co-brand or PL? (Authorization Process); 208: Yes—Send authorization request message for purchase total (Authorization Process); 206: No—BAU (Authorization Process); 214: Is authorization approved? (Authorization Process); 212: Yes—Receive authorization response message and complete purchase (Authorization Process); 216: No—BAU (Authorization Process); and 218: BAU: send clearing data to acquirer (Clearing Process).

The Acquirer/Processor Steps in FIG. 6 are 302: Receive authorization request message and send to the Transaction Handler (i.e., Visa Network) (Authorization Process); and 304: Receive authorization response message and send to Merchant (Response code 10=partial authorization).

The Transaction Handler (i.e., Visa Network) Steps in FIG. 6 are: 402: Receive authorization request message and send to Issuer (Authorization Process); and 404: Receive authorization response message and send to acquirer (Authorization Process).

The Issuer/Processor Steps in FIG. 6 are: 502: Validate authorization request (Authorization Process); 506: Is this the first time that a purchase is being made with this card account? (Authorization Process); 508: Yes—Calculate initial purchase discount, respond with adjusted amount (Authorization Process); and 504: No—Send BAU authorization response message (Authorization Process).

Note that all of the Steps 102 through 508 are within the Authorization Process except for step 218 which is within the Clearing Process.

Implementations With Different Transaction Amounts in the Authorization Request and Response

In one implementation, a method can be performed by hardware executing software. The method is conducted at a transaction hander who receives an authorization request for a transaction from a merchant's acquirer. The transaction is conducted between the merchant and an accountholder on an account issued by an issuer to the accountholder. The account is a private label account that can only be used to conduct transactions with the merchant. The authorization request includes an amount for the transaction. The transaction handler sends the authorization request for delivery to the issuer and received back an authorization response that includes an amount different than the amount for the transaction. The transaction handler then send the authorization response to the merchant's acquirer. In this implementation, the issuer can be the acquirer.

After the authorization response is sent to the acquirer, the transaction handler can facilitated clearing and settlement of the transaction on the account between the issuer and the merchant's acquirer for the amount in the authorization response.

In one alternative, The authorization response for the transaction that is received and sent by the transaction handler can include an indicator from the issuer that the transaction is the first such transaction that is conducted on the account. If so, then the difference between the amounts in the authorization request and the authorization response can be based upon a promotion as determined from the indicator from the issuer that the transaction is the first said transaction conducted on the account. As such, the promotion is given to the accountholder as an incentive to begin using the account with the merchant.

In another alternative, the authorization request for the transaction received and sent by the transaction handler can include an identifier for a item being purchased by the accountholder from the merchant. If so, then the difference between the amounts in the authorization request and the authorization response can be based upon a promotion for the item as determined from the identifier for the item being purchased by the accountholder from the merchant. As such, a price difference is given to the accountholder because of their purchase of the item.

The transaction can be processed for authorization, clearing and settlement in an open loop system. As such, in addition to handling transactions on private label accounts, the transaction handler can also receive and send a plurality of other such authorization requests; and other such authorization responses each of which can be for other such transactions. Each other such transaction can be conducted on a respective other such account, and each such account can be used at any of a number of different merchants—not just one merchant as in the case of a private label account.

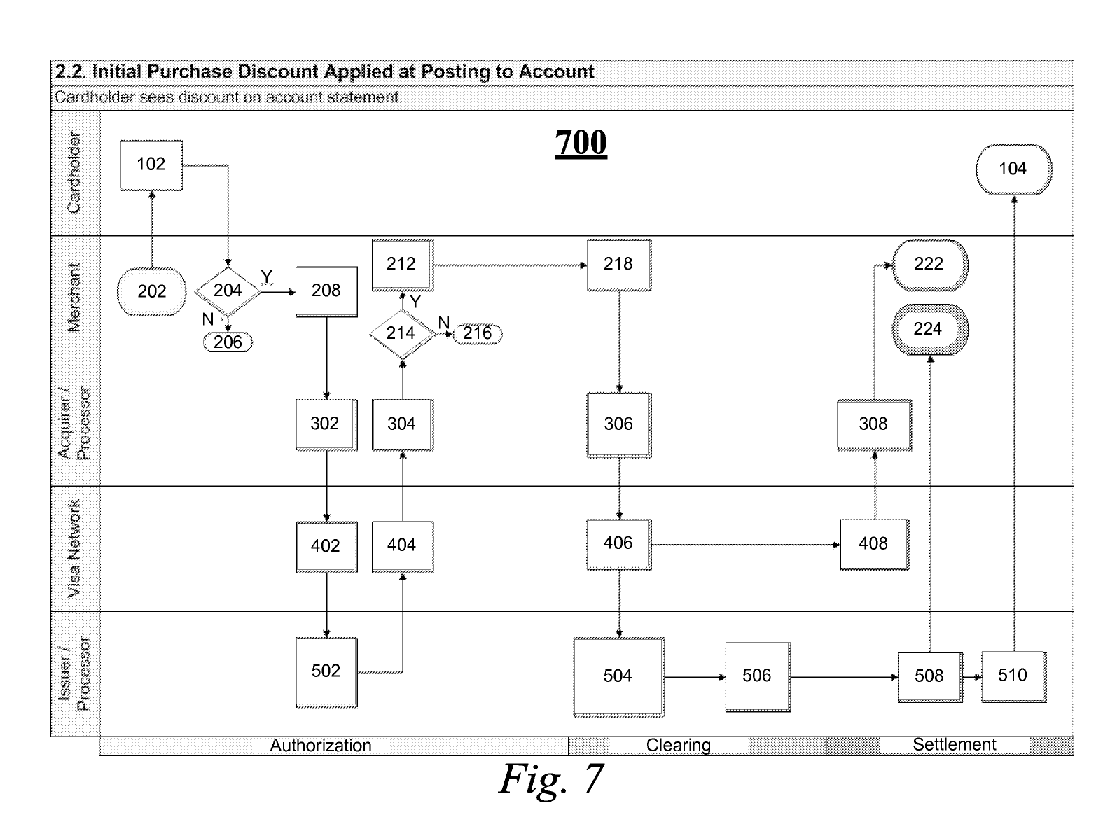

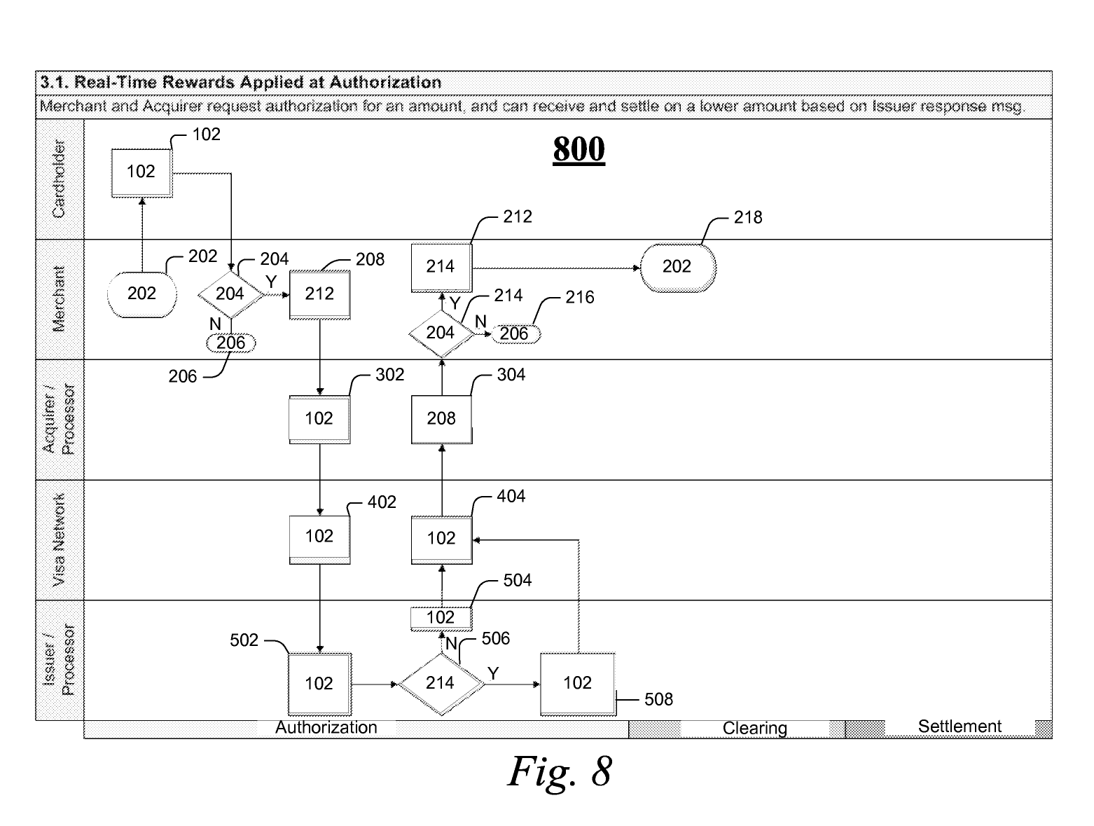

In general, FIGS. 7-8 are exemplary of the above implementation where there are different transaction amounts in the authorization request and the authorization response.

FIG. 7 at 2.2 labeled “Initial Purchase Discount at Posting” depicts a flowchart illustrating an exemplary process 700 for determining a promotional discount for an item purchased by a Cardholder in a transaction with a Merchant, where the discount is not applied at the time of purchase but is applied as a statement credit to the account of the account holder (cardholder) whose account was used to conduct the transaction with the Merchant.

Process 700 reflects that there is no impact to the authorization process, or to the clearing and settlement process. The issuer, when posting to the account, recognizes a qualifying event (e.g., the first purchase) and makes the necessary adjustments for the initial purchase discount. This does not involve the transaction Handler (i.e., Visa Network), where the activities at posting is BAU.

The Cardholder Steps in FIG. 7 are: 102: Swipe card at POS (Authorization Process); and 104: Statement to cardholder (Settlement Process).

The Merchant Steps in FIG. 7 are: 202: Inventory goods in basket (Authorization Process); 204: Is BIN Co-brand or PL? (Authorization Process); 208: Yes—Send authorization request message for purchase total (Authorization Process); 206: No—BAU (Authorization Process); 214: Is authorization approved? (Authorization Process); 212: Yes—receive authorization response message and complete purchase (Authorization Process); 216: No—BAU (Authorization Process); 218: Send Clearing data to acquirer (Clearing Process); 222: Settle entire purchase amount with acquirer (Settlement Process); and 224: Settle with issuer (Settlement Process).

The Acquirer/Processor Steps in FIG. 7 are: 302: Receive authorization request message and send to Transaction Handler (i.e., Visa); 304: Receive authorization response message and send to Merchant; 306: Map proprietary clearing data from Merchant into Visa clearing item(s) and send to Visa (Clearing Process); and 308: Receive settlement report, calculate discounts & send to merchant (Settlement Process.

The Transaction Handler (i.e., Visa Network) Steps in FIG. 7 are 402: Receive authorization request message and send to issuer; 404: Receive authorization response message and send to acquirer; 406: Receive clearing data and send to issuer (Clearing Process); and 408: Calculate settlement between Acquirer and Issuer: provide reporting; send wire (this is the first settlement) (Settlement Process).

The Issuer/Processor Steps in FIG. 7 are: 502: Validate authorization request message and send authorization response message; 504: Interrogate contents of SKU/UPC from merchant or purchase timing characteristic. Qualify and perform any special merchant settlement (this is the second settlement) (Clearing Process); 506: If this is a promotion and/or the first time that the account is used in a purchase, then apply discount (Clearing Process); 508: Initiate settlement (Settlement Process); and 540: Process data for cardholder statement (Settlement Process).

FIG. 8 at 3.1, labeled “Real Time Rewards at Authorization”, depicts a flowchart illustrating an exemplary process 800 for determining a promotional reward to a Cardholder who purchases an item in a transaction with a Merchant upon the account of the Cardholder, where the reward is received by the Cardholder at the time of the transaction, and where the Merchant and the Acquirer request authorization for an amount for the purchase of the item and can receive and settle for a lower amount based upon a response that is received from the Issuer during the Authorization Process. Note that all of the Steps 102 through 508 are within the Authorization Process except for step 218 which is within the Clearing Process.

Process 800 is an implementation of an open loop transaction in which part of the transaction is conducted with multiple parties. The merchant rings up the total basket, the transaction goes through the system and then the issuer identifies in the transaction authorization response message information about the promotion having been applied. There are two (2) options: (1st Option) an information item is printed on the consumer's receipt, such as “You got $10 off” where the issuer pays for the discount but tells the cardholder about the discount; or (2nd Option) the issuer modifies the transaction amount itself by the percentage and the issuer returns a value that the merchant will settle that reflects the discount, so the difference is who is paying for the discount.

A merchant and an acquirer initiate an authorization request for the full purchase amount, indicating POS capability to settle an amount less than the amount in the authorization request. (The merchant and acquirer could also include a value to indicate a particular reward; or could also include the SKU.) The issuer receives the authorization request message and determines if the transaction qualifies for an instant POS reward. If the transaction qualifies, the issuer replies with an adjusted amount in the authorization response message and includes a specialized response code to indicate an approval for less than the requested amount. The POS recognizes the reduced approval amount and creates a clearing item for the approved amount. Compensating the merchant for the instant POS reward is determined by the merchant and the issuer.

The reward happens at authorization in Process 800, where the SKU is captured at the POS by the merchant and is included in a message to the issuer-processor (real time and/or authorization). Process 800 looks at what was purchased to apply an additional modification in the form of a discount by an item (level III, product level data, SKU, UPC).

The Cardholder Step in FIG. 8 is 102: Swipe card at POS.

The Merchant Steps in FIG. 8 are 202: Inventory goods in basket; 204: Is Bank Identification Number (BIN) a Co-branded number or a Private Label (PL) number?; 208: Yes—send authorization request message for purchase total; 206: No—BAU; 214: Is authorization approved?; 212: Yes—receive authorization and complete purchase; and 216: No—BAU; 218: BAU: send clearing data to acquirer (Clearing Process).

The Acquirer/Processor Steps in FIG. 8 are 302: Receive authorization request message and send to the Transaction Handler (i.e., Visa Network); and 304: Receive authorization response message to send to merchant (Need to consider if there needs to be a specialized approval response code to convey that approved amount is different than requested amount)

The Transaction Hander (i.e., Visa Network) Steps in FIG. 8 are 402: Receive authorization request message and send to Issuer; and 404: Receive authorization response message and send to Acquirer.

The Issuer/Processor Steps in FIG. 8 are 502: Validate authorization request; 506: Does account qualify for real-time reward? (Assumes: issuer runs and maintains real-time rewards engine); 508: Yes—Calculate reward discount, respond with adjusted amount (making merchant whole for amount of real-time reward (instant discount) as between merchant and issuer); and 504: No—Send authorization response message.

The steps, methods, processes, and devices described in connection with the implementations disclosed herein, are made with reference to the Figures, in which like numerals represent the same or similar elements. While described in terms of the best mode, it will be appreciated by those skilled in the art that the description is intended to cover alternatives, modifications, and equivalents as may be included within the spirit and scope of the invention as defined by the appended claims and their equivalents as supported by the following disclosure and drawings.

Exemplary Payment Processing System.

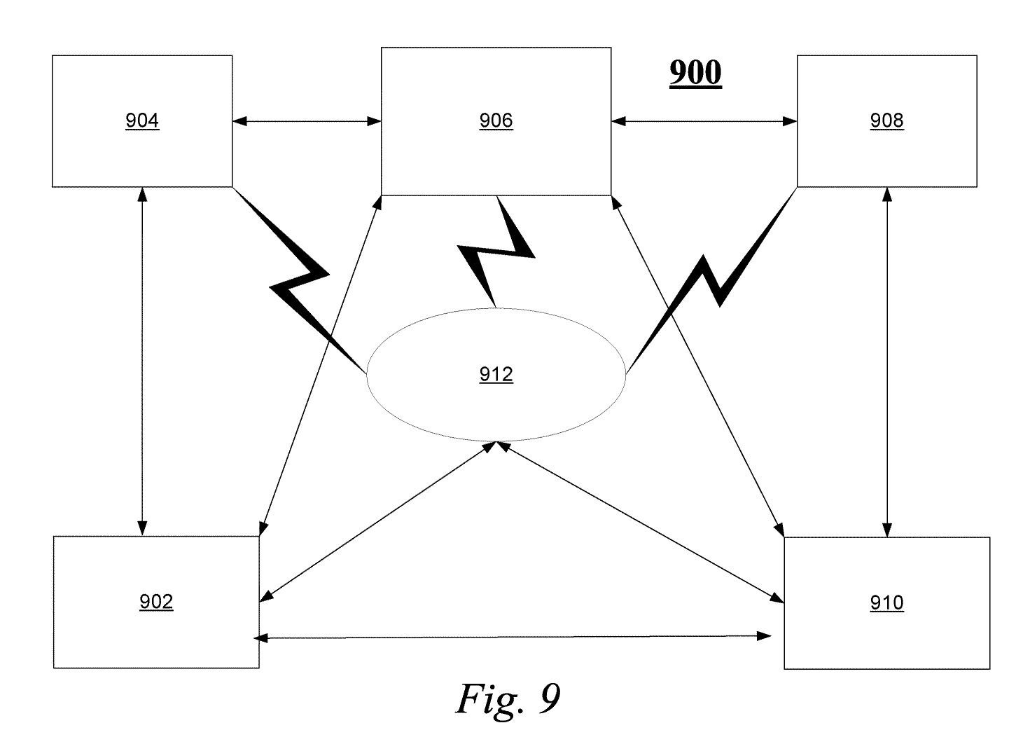

FIG. 9 illustrates an exemplary payment processing system, depicting the general environment for conducting a transaction on an account. In general, a transaction includes participation from different entities that are a component of a payment processing system 900, including an account holder 908 (e.g.; the consumer associated with the account), a transaction handler 902, such as a credit card company, an acquirer 106, a merchant 910, and an issuer 904. Acquirer 906 and issuer 904 can communicate through transaction handler 902. Merchant 910 may be a person or entity that sells goods or services. Merchant 910 may also be, for instance, a manufacturer, a distributor, a retailer, a load agent, a drugstore, a grocery store, a gas station, a hardware store, a supermarket, a boutique, a restaurant, or a doctor's office. In a business-to-business setting, the account holder 908 may be a second merchant making a purchase from another merchant 910. Merchant 910 may utilize at least one point-of-sale terminal (POS) that can communicate with acquirer 906, transaction handler 902, or issuer 904. Thus, the POS terminal is in operative communication with the payment processing system 900.

Typically, a transaction begins with account holder 908 presenting a portable consumer device to merchant 910 to initiate an exchange for a good or service. The portable consumer device may be associated with account information stored in an account database 912, accessible by issuer 904, transaction handler 902, and/or acquirer 906. The portable consumer device may include a payment card, a gift card, a smartcard, a smart media, a payroll card, a healthcare card, a wrist band, a machine readable medium containing account information, a keychain device, such as a SPEEDPASS® device commercially available from ExxonMobil Corporation, or a supermarket discount card, a cellular phone, personal digital assistant, a pager, a security card, an access card, a wireless terminal, or a transponder. The portable consumer device may include a volatile or non-volatile memory to store information such as the account number or an account holder's name.

Merchant 910 may use the POS terminal to obtain account information, such as an account number, from the portable consumer device. The portable consumer device may interface with the POS terminal using a mechanism including any suitable electrical, magnetic, or optical interfacing system such as a contactless system using radio frequency or magnetic field recognition system or contact system such as a magnetic stripe reader. The POS terminal sends a transaction authorization request to the issuer 904 of the portable consumer device. Alternatively, or in combination, the portable consumer device may communicate with issuer 904, transaction handler 902, or acquirer 906.

Issuer 904 may authorize the transaction using transaction handler 902. Transaction handler 902 may also clear the transaction. Authorization includes issuer 904, or transaction handler 902 on behalf of issuer 904, authorizing the transaction in connection with issuer 904's instructions such as through the use of business rules. The business rules could include instructions or guidelines from transaction handler 902, account holder 908, merchant 910, acquirer 906, issuer 904, a financial institution, or combinations thereof. Transaction handler 902 may maintain a log or history of authorized transactions. Once approved, merchant 910 will record the authorization, allowing account holder 908 to receive the good or service.

Merchant 910 may, at discrete periods, such as the end of the day, submit a list of authorized transactions to acquirer 906 or other components of the payment processing system 900. Transaction handler 902 may compare the submitted authorized transaction list with its own log of authorized transactions. If a match is found, transaction handler 902 may route authorization transaction amount requests from the corresponding acquirer 906 to the corresponding issuer 904 involved in each transaction. Once acquirer 906 receives the payment of the authorized transaction amount from issuer 904, it can forward the payment to merchant 910 less any transaction costs, such as fees. If the transaction involves a debit or pre-paid card, acquirer 906 may choose not to wait for the initial payment prior to paying merchant 910.

There may be intermittent steps in the foregoing process, some of which may occur simultaneously. For example, acquirer 906 can initiate the clearing and settling process, which can result in payment to acquirer 906 for the amount of the transaction. Acquirer 906 may request from transaction handler 902 that the transaction be cleared and settled. Clearing includes the exchange of financial information between the issuer 904 and the acquirer 906 and settlement includes the exchange of funds. Transaction handler 902 can provide services in connection with settlement of the transaction. The settlement of a transaction includes depositing an amount of the transaction settlement from a settlement house, such as a settlement bank, which transaction handler 902 typically chooses, into a clearinghouse, such as a clearing bank, that acquirer 906 typically chooses. Issuer 904 deposits the same from a clearinghouse, such as a clearing bank, which issuer 904 typically chooses, into the settlement house. Thus, a typical transaction involves various entities to request, authorize, and fulfill processing the transaction.

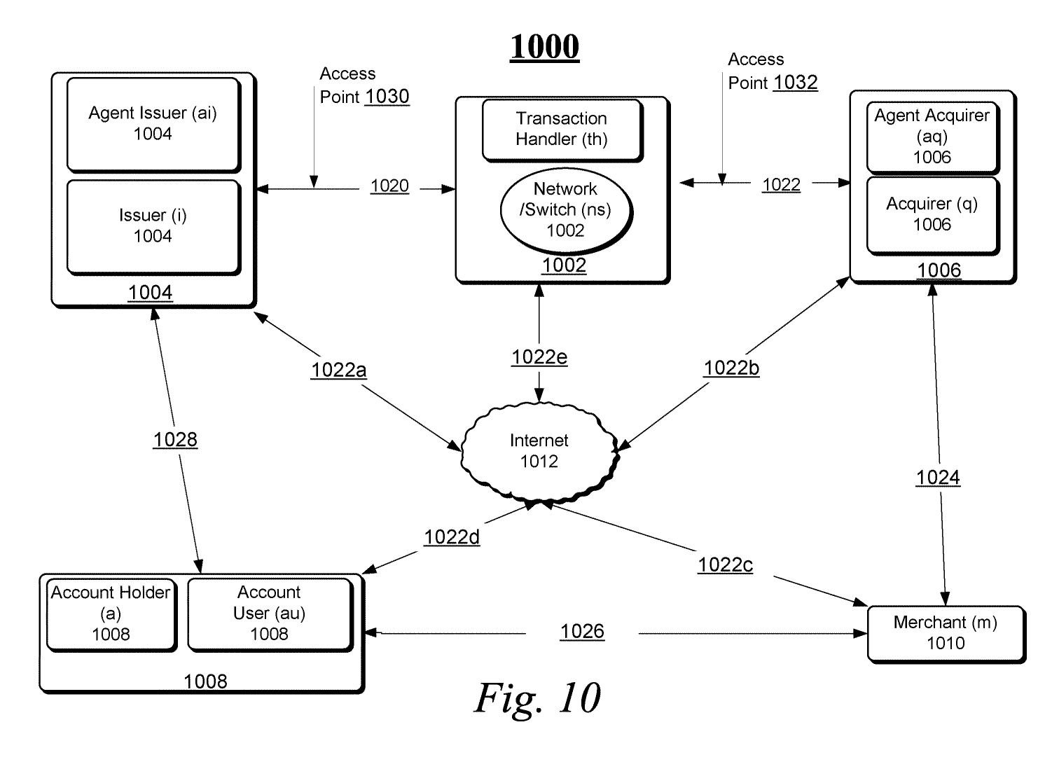

Referring to FIG. 10, a transaction processing system 1000 is seen. The general environment of FIG. 10 include that of a merchant (m) 1010, such as the merchant, who can conduct a transaction for goods and/or services with an account user (au) (e.g., consumer) on an account issued to an account holder (a) 1008 by an issuer (i) 1004, where the processes of paying and being paid for the transaction are coordinated by at least one transaction handler (th) 1002 (e.g., the transaction handler) (collectively “users”). The transaction includes participation from different entities that are each a component of the transaction processing system 1000.

The transaction processing system 1000 may have at least one of a plurality of transaction handlers (th) 1002 that includes transaction handler (1) 1002 through transaction handler (TH) 1002, where TH can be up to and greater than an eight digit integer.

The transaction processing system 1000 has a plurality of merchants (m) 1010 that includes merchant (1) 1010 through merchant (M) 1010, where M can be up to and greater than an eight digit integer. Merchant (m) 1010 may be a person or entity that sells goods and/or services. Merchant (m) 1010 may also be, for instance, a manufacturer, a distributor, a retailer, a load agent, a drugstore, a grocery store, a gas station, a hardware store, a supermarket, a boutique, a restaurant, or a doctor's office. In a business-to-business setting, the account holder (a) 1008 may be a second merchant (m) 1010 making a purchase from another merchant (m) 1010.

Transaction processing system 1000 includes account user (1) 1008 through account user (AU) 1008, where AU can be as large as a ten digit integer or larger. Each account user (au) conducts a transaction with merchant (m) 1010 for goods and/or services using the account that has been issued by an issuer (i) 1004 to a corresponding account holder (a) 1008. Data from the transaction on the account is collected by the merchant (m) 1010 and forwarded to a corresponding acquirer (a) 1006. Acquirer (a) 1006 forwards the data to transaction handler (th) 1002 who facilitates payment for the transaction from the account issued by the issuer (i) 1004 to account holder (a) 1008.

Transaction processing system 1000 has a plurality of acquirers (q) 1006. Each acquirer (q) 1006 may be assisted in processing one or more transactions by a corresponding agent acquirer (aq) 1006, where ‘q’ can be an integer from 1 to Q, where aq can be an integer from 1 to AQ, and where Q and AQ can be as large as a eight digit integer or larger. Each acquirer (q) 1006 may be assisted in processing one or more transactions by a corresponding agent acquirer (aq) 1006, where ‘q’ can be an integer from 1 to Q, where aq can be an integer from 1 to AQ, and where Q and AQ can be as large as a eight digit integer or larger.

The transaction handler (th) 1002 may process a plurality of transactions within the transaction processing system 1000. The transaction handler (th) 1002 can include one or a plurality or networks and switches (ns) 1002. Each network/switch (ns) 1002 can be a mainframe computer in a geographic location different than each other network/switch (ns) 1002, where ‘ns’ is an integer from one to NS, and where NS can be as large as a four digit integer or larger.

Dedicated communication systems 1020, 1022 (e.g., private communication network(s)) facilitate communication between the transaction handler (th) 1002 and each issuer (i) 1004 and each acquirer (a) 1006. A Network 1012, via e-mail, the World Wide Web, cellular telephony, and/or other optionally public and private communications systems, can facilitate communications 1022a-1022e among and between each issuer (i) 1004, each acquirer (a) 1006, each merchant (m) 1010, each account holder (a) 1008, and the transaction handler (th) 1002. Alternatively and optionally, one or more dedicated communication systems 1024, 1026, and 1028 can facilitate respective communications between each acquirer (a) 1006 and each merchant (m) 1010, each merchant (m) and each account holder (a) 1008, and each account holder (a) 1008 and each issuer (i) 1004, respectively.

The Network 1012 may represent any of a variety of suitable means for exchanging data, such as: an Internet, an intranet, an extranet, a wide area network (WAN), a local area network (LAN), a virtual private network, a satellite communications network, an Automatic Teller Machine (ATM) network, an interactive television network, or any combination of the forgoing. Network 1012 may contain either or both wired and wireless connections for the transmission of signals including electrical, magnetic, and a combination thereof. Examples of such connections are known in the art and include: radio frequency connections, optical connections, etc. To illustrate, the connection for the transmission of signals may be a telephone link, a Digital Subscriber Line, or cable link. Moreover, network 1012 may utilize any of a variety of communication protocols, such as Transmission Control Protocol/Internet Protocol (TCP/IP), for example. There may be multiple nodes within the network 1012, each of which may conduct some level of processing on the data transmitted within the transaction processing system 1000.

Users of the transaction processing system 1000 may interact with one another or receive data about one another within the transaction processing system 1000 using any of a variety of communication devices. The communication device may have a processing unit operatively connected to a display and memory such as Random Access Memory (“RAM”) and/or Read-Only Memory (“ROM”). The communication device may be combination of hardware and software that enables an input device such as a keyboard, a mouse, a stylus and touch screen, or the like.

For example, use of the transaction processing system 1000 by the account holder (a) 1008 may include the use of a portable consumer device (PCD). The PCD may be one of the communication devices, or may be used in conjunction with, or as part of, the communication device. The PCD may be in a form factor that can be: a card (e.g., bank card, payment card, financial card, credit card, charge card, debit card, gift card, transit pass, smart card, access card, a payroll card, security card, healthcare card, or telephone card), a tag, a wristwatch, wrist band, a key ring, a fob (e.g., SPEEDPASS® commercially available from ExxonMobil Corporation), a machine readable medium containing account information, a pager, a cellular telephone, a personal digital assistant, a digital audio player, a computer (e.g., laptop computer), a set-top box, a portable workstation, a minicomputer, or a combination thereof. The PCD may have near field or far field communication capabilities (e.g., satellite communication or communication to cell sites of a cellular network) for telephony or data transfer such as communication with a global positioning system (GPS). The PCD may support a number of services such as SMS for text messaging and Multimedia Messaging Service (MMS) for transfer of photographs and videos, electronic mail (email) access.

The PCD may include a computer readable medium. The computer readable medium, such as a magnetic stripe or a memory of a chip or a chipset, may include a volatile, a non-volatile, a read only, or a programmable memory that stores data, such as an account identifier, a consumer identifier, and/or an expiration date. The computer readable medium may including executable instructions that, when executed by a computer, the computer will perform a method. For example, the computer readable memory may include information such as the account number or an account holder (a) 1008's name.

Examples of the PCD with memory and executable instructions include: a smart card, a personal digital assistant, a digital audio player, a cellular telephone, a personal computer, or a combination thereof. To illustrate, the PCD may be a financial card that can be used by a consumer to conduct a contactless transaction with a merchant, where the financial card includes a microprocessor, a programmable memory, and a transponder (e.g., transmitter or receiver). The financial card can have near field communication capabilities, such as by one or more radio frequency communications such as are used in a “Blue Tooth” communication wireless protocol for exchanging data over short distances from fixed and mobile devices, thereby creating personal area networks.

Merchant (m) 1010 may utilize at least one POI terminal (e.g., Point of Service or browser enabled consumer cellular telephone); that can communicate with the account user (au) 1008, the acquirer (a) 1006, the transaction handler (th) 1002, or the issuer (i) 1004. A Point of Interaction (POI) can be a physical or virtual communication vehicle that provides the opportunity, through any channel to engage with the consumer for the purposes of providing content, messaging or other communication, related directly or indirectly to the facilitation or execution of a transaction between the merchant (m) 1010 and the consumer. Examples of the POI include: a physical or virtual Point of Service (POS) terminal, the PCD of the consumer, a portable digital assistant, a cellular telephone, paper mail, e-mail, an Internet website rendered via a browser executing on computing device, or a combination of the forgoing. Thus, the POI terminal is in operative communication with the transaction processing system 1000.

The PCD may interface with the POI using a mechanism including any suitable electrical, magnetic, or optical interfacing system such as a contactless system using radio frequency, a magnetic field recognition system, or a contact system such as a magnetic stripe reader. To illustrate, the POI may have a magnetic stripe reader that makes contact with the magnetic stripe of a healthcare card (e.g., Flexible Savings Account card) of the consumer. As such, data encoded in the magnetic stripe on the healthcare card of consumer read and passed to the POI at merchant (m) 1010. These data can include an account identifier of a healthcare account. In another example, the POI may be the PCD of the consumer, such as the cellular telephone of the consumer, where the merchant (m) 1010, or an agent thereof, receives the account identifier of the consumer via a webpage of an interactive website rendered by a browser executing on a World Wide Web (Web) enabled PCD.

Typically, a transaction begins with account user (au) 1008 presenting the portable consumer device to the merchant (m) 1010 to initiate an exchange for resources (e.g., a good or service). The portable consumer device may be associated with an account (e.g., a credit account) of account holder (a) 1008 that was issued to the account holder (a) 1008 by issuer (i) 1004.

Merchant (m) 1010 may use the POI terminal to obtain account information, such as a number of the account of the account holder (a) 1008, from the portable consumer device. The portable consumer device may interface with the POI terminal using a mechanism including any suitable electrical, magnetic, or optical interfacing system such as a contactless system using radio frequency or magnetic field recognition system or contact system such as a magnetic stripe reader. The POI terminal sends a transaction authorization request to the issuer (i) 1004 of the account associated with the PCD. Alternatively, or in combination, the PCD may communicate with issuer (i) 1004, transaction handler (th) 1002, or acquirer (a) 1006.

Issuer (i) 1004 may authorize the transaction and forward same to the transaction handler (th) 1002. Transaction handler (th) 1002 may also clear the transaction. Authorization includes issuer (i) 1004, or transaction handler (th) 1002 on behalf of issuer (i) 1004, authorizing the transaction in connection with issuer (i) 1004's instructions such as through the use of business rules. The business rules could include instructions or guidelines from the transaction handler (th) 1002, the account holder (a) 1008, the merchant (m) 1010, the acquirer (a) 1006, the issuer (i) 1004, a related financial institution, or combinations thereof. The transaction handler (th) 1002 may, but need not, maintain a log or history of authorized transactions. Once approved, the merchant (m) 1010 may record the authorization, allowing the account user (au) 1008 to receive the good or service from merchant (m) or an agent thereof.

The merchant (m) 1010 may, at discrete periods, such as the end of the day, submit a list of authorized transactions to the acquirer (a) 1006 or other transaction related data for processing through the transaction processing system 1000. The transaction handler (th) 1002 may optionally compare the submitted authorized transaction list with its own log of authorized transactions. The transaction handler (th) 1002 may route authorization transaction amount requests from the corresponding the acquirer (a) 1006 to the corresponding issuer (i) 1004 involved in each transaction. Once the acquirer (a) 1006 receives the payment of the authorized transaction from the issuer (i) 1004, the acquirer (a) 1006 can forward the payment to the merchant (m) 1010 less any transaction costs, such as fees for the processing of the transaction. If the transaction involves a debit or pre-paid card, the acquirer (a) 1006 may choose not to wait for the issuer (i) 1004 to forward the payment prior to paying merchant (m) 1010.

There may be intermittent steps in the foregoing process, some of which may occur simultaneously. For example, the acquirer (a) 1006 can initiate the clearing and settling process, which can result in payment to the acquirer (a) 1006 for the amount of the transaction. The acquirer (a) 1006 may request from the transaction handler (th) 1002 that the transaction be cleared and settled. Clearing includes the exchange of financial information between the issuer (i) 1004 and the acquirer (a) 1006 and settlement includes the exchange of funds. The transaction handler (th) 1002 can provide services in connection with settlement of the transaction. The settlement of a transaction includes depositing an amount of the transaction settlement from a settlement house, such as a settlement bank, which transaction handler (th) 1002 typically chooses, into a clearinghouse bank, such as a clearing bank, that acquirer (a) 1006 typically chooses. The issuer (i) 1004 deposits the same from a clearinghouse bank, such as a clearing bank, which the issuer (i) 1004 typically chooses, into the settlement house. Thus, a typical transaction involves various entities to request, authorize, and fulfill processing the transaction.

The transaction processing system 1000 will preferably have network components suitable for scaling the number and data payload size of transactions that can be authorized, cleared and settled in both real time and batch processing. These include hardware, software, data elements, and storage network devices for the same. Examples of transaction processing system 1000 include those operated, at least in part, by: American Express Travel Related Services Company, Inc; MasterCard International, Inc.; Discover Financial Services, Inc.; First Data Corporation; Diners Club International, LTD; Visa Inc.; and agents of the foregoing.

Each of the network/switch (ns) 1002 can include one or more data centers for processing transactions, where each transaction can include up to 100 kilobytes of data or more. The data corresponding to the transaction can include information about the types and quantities of goods and services in the transaction, information about the account holder (a) 1008, the account user (au) 1008, the merchant (m) 1010, tax and incentive treatment(s) of the goods and services, coupons, rebates, rewards, loyalty, discounts, returns, exchanges, cash-back transactions, etc.

By way of example, network/switch (ns) 1002 can include one or more mainframe computers (e.g., one or more IBM mainframe computers) for one or more server farms (e.g., one or more Sun UNIX Super servers), where the mainframe computers and server farms can be in diverse geographic locations.

Each issuer (i) 1004 (or agent issuer (ai) 1004 thereof) and each acquirer (a) 1006 (or agent acquirer (aq) 1006 thereof) can use or more router/switch (e.g., Cisco™ routers/switches) to communicate with each network/switch (ns) 1002 via dedicated communication systems.

FIG. 10 includes one or more transaction handlers transaction handler (th) 1002 and access points 1030, 1032. Other entities such as drawee banks and third party authorizing agents may also connect to the network through an access point. An interchange center is a data processing center that may be located anywhere in the world. In one embodiment, there are two in the United States and one each in the United Kingdom and in Japan. Each interchange center houses the computer system that performs the network transaction processing. The interchange center serves as the control point for the telecommunication facilities of the network, which comprise high speed leased lines or satellite connections based on IBM SNA protocol. Preferable, the communication lines that connect an interchange center (transaction handlers 202, 1406) to remote entities use dedicated high-bandwidth telephone circuits or satellite connections based on the IBM SNA-LUO communication protocol. Messages are sent over these lines using any suitable implementation of the ISO 8583 standard.

Access points 1030, 1032 are typically made up of small computer systems located at a processing center that interfaces between the center's host computer and the interchange center The access point facilitates the transmission of messages and files between the host and the interchange center supporting the authorization, clearing and settlement of transaction. Telecommunication links between the acquirer (q) 1006 and its access point, and between the access point and issuer (i) 1004 are typically local links within a center and use a proprietary message format as preferred by the center.

A data processing center (such as is located within an acquirer, issuer, or other entity) houses processing systems that support merchant and business locations and maintains customer data and billing systems. Preferably, each processing center is linked to one or two interchange centers. Processors are connected to the closest interchange, and if the network experiences interruptions, the network automatically routes transactions to a secondary interchange center. Each interchange center is also linked to all of the other interchange centers. This linking enables processing centers to communicate with each other through one or more interchange centers. Also, processing centers can access the networks of other programs through the interchange center. Further, the network ensures that all links have multiple backups. The connection from one point of the network to another is not usually a fixed link; instead, the interchange center chooses the best possible path at the time of any given transmission. Rerouting around any faulty link occurs automatically.

Transaction handler (th) 1002 can store information about transactions processed through transaction processing system 1000 in data warehouses such as may be incorporated as part of the plurality of networks/switches 1002. This information can be data mined. The data mining transaction research and modeling can be used for advertising, account holder and merchant loyalty incentives and rewards, fraud detection and prediction, and to develop tools to demonstrate savings and efficiencies made possible by use of the transaction processing system 1000 over paying and being paid by cash, or other traditional payment mechanisms.

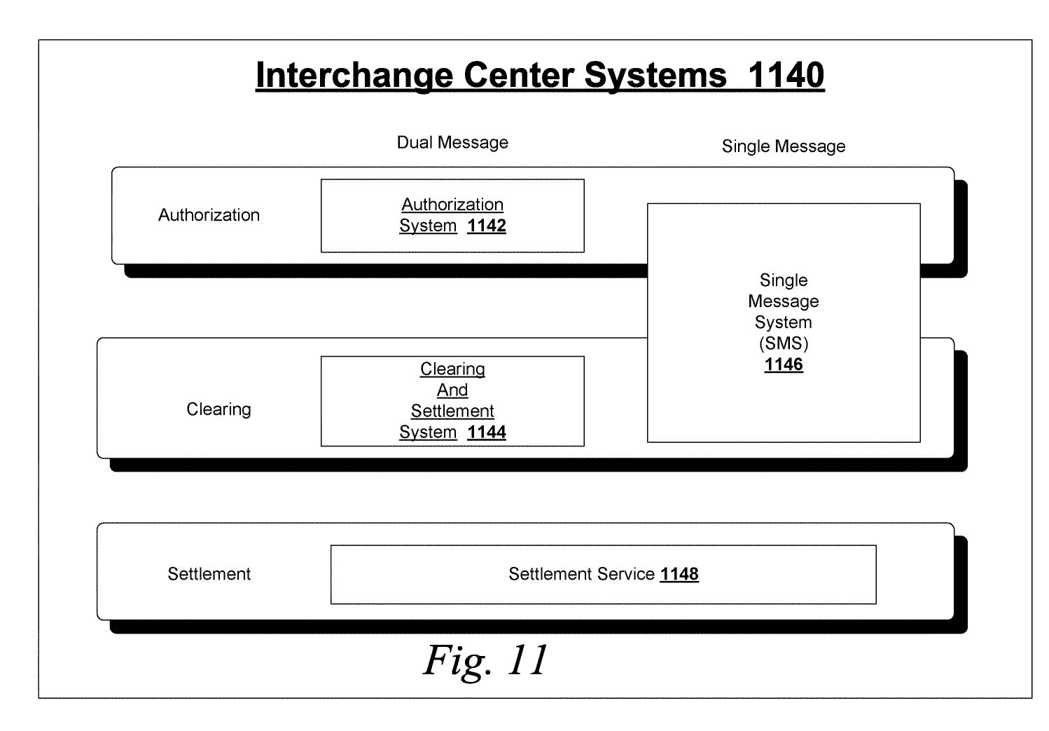

FIG. 11 illustrates systems 1140 housed within an interchange center to provide on-line and off-line transaction processing. For dual message transaction, authorization system 1142 provides authorization. System 1142 supports on-line and off-line functions, and its file includes internal systems tables, a customer database and a merchant central file. The on-line functions of system 1142 support dual message authorization processing. This processing involves routing, cardholder and card verification and stand-in processing, and other functions such as file maintenance. Off-line functions including reporting, billing, and generating recovery bulletins. Reporting includes authorization reports, exception file and advice file reports, POS reports and billing reports. A bridge from system 1142 to system 1146 makes it possible for members using system 1142 to communicate with members using system 1146 and access the SMS gateways to outside networks.

Clearing and settlement system 1144 clears and settles previously authorized dual message transactions. Operating six days a week on a global basis, system 1144 collects financial and non-financial information and distributes reports between members It also calculates fees, charges and settlement totals and produces reports to help with reconciliation. A bridge forms an interchange between system 1144 processing centers and system 846 processing centers.

Single message system 1146 processes full financial transactions. System 1146 can also process dual message authorization and clearing transactions, and communicates with system 1142 using a bridge and accesses outside networks as required. System 1146 processes Visa, Plus Interlink and other card transactions. The SMS files comprise internal system tables that control system access and processing, and the cardholder database, which contains files of cardholder data used for PIN verification and stand-in processing authorization. System 1146 on-line functions perform real-time cardholder transaction processing and exception processing for authorization as well as full financial transactions. System 1146 also accumulates reconciliation and settlement totals. System 1146 off-line functions process settlement and funds transfer requests and provide settlement and activities reporting. Settlement service 1148 consolidates the settlement functions of system 1144 and 1146, including Interlink, into a single service for all products and services. Clearing continues to be performed separately by system 1144 and system 1146.

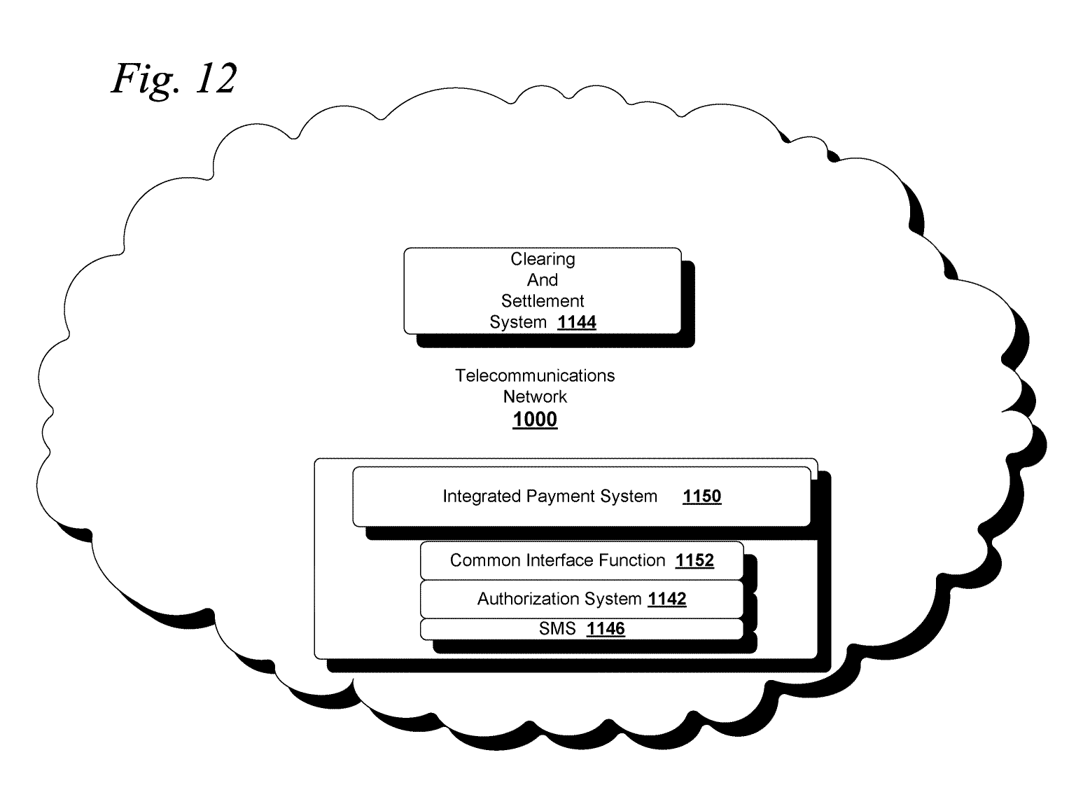

FIG. 12 illustrates another view of components of FIG. 10 as a telecommunications network 1000. Integrated payment system 1150 is the primary system for processing all on-line authorization and financial request transactions. System 1150 reports both dual message and single message processing. In both cases, settlement occurs separately. The three main software components are the common interface function 1152, authorization system 1142 and single message system 1146.

Common interface function 1152 determines the processing required for each message received at an interchange center. It chooses the appropriate routing, based on the source of the message (system 1142, 1144 or 1146), the type of processing request and the processing network. This component performs initial message editing, and, when necessary, parses the message and ensures that the content complies with basic message construction rules. Common interface function 1152 routes messages to their system 1142 or system 1146 destinations.

The VisaNet® system is an example component of the transaction handler (th) 1002 in the transaction processing system 1000. Presently, the VisaNet® system is operated in part by Visa Inc. As of 2006, the VisaNet® system Inc. was processing around 300 million transaction daily, on over 1 billion accounts used in over 170 countries. Financial instructions numbering over 16,000 connected through the VisaNet® system to around 30 million merchants (m) 610. In 2007, around 71 billion transactions for about 4 trillion U.S. dollars were cleared and settled through the VisaNet® system, some of which involved a communication length of around 24,000 miles in around two (2) seconds and during which a plurality of stops are made for processing data in the transaction.

The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes. Based on the disclosure and teachings provided herein, a person of ordinary skill in the art will appreciate other ways and/or methods for various implements. Moreover, it is understood that a functional step of described methods or processes, and combinations thereof can be implemented by computer program instructions that, when executed by a processor, create means for implementing the functional steps. The instructions may be included in computer readable medium that can be loaded onto a general purpose computer, a special purpose computer, or other programmable apparatus.

It is understood that the examples and implementations described herein are for illustrative purposes only and that various modifications or changes in light thereof will be suggested to persons skilled in the art and are to be included within the spirit and purview of this application and scope of the appended claims.

What is claimed is:

1. A method comprising a plurality of steps, each being performed by hardware executing software, wherein the steps include:
receiving, at a transaction handler from a merchant's acquirer, an authorization request for a transaction, wherein:
the transaction is conducted between the merchant and an accountholder on an account issued by an issuer to the accountholder;
any said transaction on the account can only be conducted with the merchant; and
the authorization request includes an amount for the transaction;
sending, from the transaction handler for delivery to the issuer, the authorization request;
receiving, at the transaction handler from the issuer, an authorization response to the authorization request, wherein the authorization response includes an amount different than the amount for the transaction; and
sending, from the transaction handler for delivery to the merchant's acquirer, the authorization response.

2. The method as defined in claim 1, wherein the issuer is the acquirer.

3. The method as defined in claim 1, wherein the steps further comprise facilitating, by the transaction handler, clearing and settlement of the transaction on the account between the issuer and the merchant's acquirer for the amount in the authorization response.

4. The method as defined in claim 1, the authorization response for the transaction received and sent by the transaction handler includes an indicator from the issuer that the transaction is the first said transaction conducted on the account.

5. The method as defined in claim 4, wherein the difference between the amounts in the authorization request and the authorization response is based upon a promotion as determined from the indicator from the issuer that the transaction is the first said transaction conducted on the account.

6. The method as defined in claim 1, wherein the authorization request for the transaction received and sent by the transaction handler includes an identifier for a item being purchased by the accountholder from the merchant.

7. The method as defined in claim 6, wherein the difference between the amounts in the authorization request and the authorization response is based upon a promotion for the item as determined from the identifier for the item being purchased by the accountholder from the merchant.

8. The method as defined in claim 1, wherein the transaction is processing for authorization, clearing and settlement in an open loop system.

9. The method as defined in claim 1, wherein:
the steps further comprise the transaction handler respectively receiving and sending a plurality of:
other said authorization requests; and
other said authorization responses;
each of the other said authorization requests and the other said authorization responses are for other said transactions;
each of the other said transactions is conducted on a respective other said account;
each of the other said accounts are issued by other said issuers to other said accountholders; and
each of the other said accountholders can conduct a transaction the other said account issued thereto with a plurality of different said merchants.

10. A computer readable medium comprising instructions which, when executed by the hardware, performs the steps of claim 1.

11. A method comprising a plurality of steps, each being performed by hardware executing software, wherein the steps include:
receiving, at a transaction handler from a merchant's acquirer, an authorization request for a transaction, wherein:
the transaction is conducted between the merchant and an accountholder on an account issued by an issuer to the accountholder;
any said transaction on the account can only be conducted with the merchant;
the issuer is the acquirer; and
the authorization request includes:
an amount for the transaction; and
an identifier for a item being purchased by the accountholder from the merchant;
sending, from the transaction handler for delivery to the issuer, the authorization request;
receiving, at the transaction handler from the issuer, an authorization response to the authorization request, wherein the authorization response includes:
an amount different than the amount for the transaction; and
an indicator from the issuer that the transaction is the first said transaction conducted on the account;
sending, from the transaction handler for delivery to the merchant's acquirer, the authorization response;
facilitating, by the transaction handler, clearing and settlement of the transaction on the account between the issuer and the merchant's acquirer for the amount in the authorization response, wherein the difference between the respective said amount in the authorization request and the authorization response is based upon at least one of:
the indicator from the issuer that the transaction is the first said transaction conducted on the account; and
the identifier for the item being purchased by the accountholder from the merchant.

12. The method as defined in claim 11, wherein:
the steps further comprise the transaction handler respectively receiving and sending a plurality of:
other said authorization requests; and
other said authorization responses;
each of the other said authorization requests and the other said authorization responses are for other said transactions;
each of the other said transactions is conducted on a respective other said account;
each of the other said accounts are issued by other said issuers to other said accountholders; and
each of the other said accountholders can conduct a transaction the other said account issued thereto with a plurality of different said merchants.

13. A computer readable medium comprising instructions which, when executed by the hardware, performs the steps of claim 11.

14. A method comprising a plurality of steps, each being performed by hardware executing software, wherein the steps include:
receiving, at a merchant, information for a transaction for a purchase of a promotion item and a non-promotional item, wherein:
information includes an identifier for:
an account issued by an issuer to the accountholder for the transaction which is being conducted on the account between the merchant and the accountholder; and
the promotional item;
and
any said transaction on the account can only be conducted with the merchant;
sending, from the merchant, an authorization request for the transaction for delivery to the issuer through a communication path through an acquirer and a transaction handler before the delivery to the issuer;
receiving, at the merchant from the acquirer, an authorization response to the authorization request;
sending, in a transmission directly from the merchant to the issuer, a promotional item settlement request that includes:
the identifier for the promotional item;
the identifier for the account; and
an identifier for the transaction;
sending, from the merchant, a transaction clearing request for the transaction for delivery to the issuer through a communication path through the acquirer and the transaction handler before the delivery to the issuer;
receiving, at the merchant, a promotional item clearing response to the promotional item settlement request, wherein the promotional item clearing response includes settlement information corresponding to promotional financing from the issuer to the account holder derived from the identifier for the promotional item;
and
receiving, at the merchant from the acquirer, a transaction clearing response to the transaction settlement request.

15. The method as defined in claim 14, wherein the issuer is the acquirer.

16. The method as defined in claim 14, wherein the authorization response includes an indicator that the transaction is the first said transaction conducted on the account.

17. The method as defined in claim 16, wherein:
the authorization request and the authorization response include different amounts for the transaction; and
the difference between the respective said amount in the authorization request and the authorization response is based upon at least one of:
the transaction is the first said transaction conducted on the account; and
the identifier for the promotional item.

18. The method as defined in claim 14, wherein the transaction is processing for authorization, clearing and settlement in an open loop system.

19. The method as defined in claim 14, wherein:
the transaction handler respectively receives and sends a plurality of:
other said authorization requests; and
other said authorization responses;
each of the other said authorization requests and the other said authorization responses are for other said transactions;
each of the other said transactions is conducted on a respective other said account;
each of the other said accounts are issued by other said issuers to other said accountholders; and
each of the other said accountholders can conduct a transaction the other said account issued thereto with a plurality of different said merchants.

20. A computer readable medium comprising instructions which, when executed by the hardware, performs the steps of claim 14.
